(19) United States
(12) Patent Application Publication
(10) Pub. No.: US 2011/0161514 A1
(43) Pub. Date: Jun. 30, 2011

(54) METHOD AND APPARATUS FOR DELEGATING COMPUTATIONALLY INTENSIVE FUNCTIONS

(75) Inventors: Martti Voutilainen, Espoo (FI); Markku Oksanen, Helsinki (FI); Harald Kaaja, Jarvenpaa (FI)

(73) Assignee: Nokia Corporation, Espoo (FI)

(21) Appl. No.: 12/649,182

(22) Filed: Dec. 29, 2009

(51) Int. Cl. G06F 15/16

(52) U.S. Cl. 709/231; 709/247

(57) ABSTRACT

A method and apparatus are provided for receiving compressed sensed data at a device and providing for decompression of the compressed sensed data at a delegated resource. A method of using resources may be provided with superior processing capacity and/or power capacity for computationally intensive decompression of compressed sensed data. A method may include determining a target recipient device for decompressed data, determining the appropriate decompressed data format for the decompressed data, and determining a delegated resource to select for decompression of the compressed sensed data. The method may further include providing for transmission of the compressed sensed data to the delegated resource.

### TECHNOLOGICAL FIELD

Embodiments of the present invention relate generally to computing technology and, more particularly, relate to methods and apparatus for delegating computationally intensive functions to a remote device with superior power resources to minimize local power consumption.

### BACKGROUND

Mobile devices are often used to create still pictures and videos, and used to display or play multimedia such as pictures, videos, and music. Such multimedia is often loaded to a device using local wireless access such as Radio Frequency Identification (RFID) tags, traditional cellular networks, Bluetooth communications, and Wi-Fi among others. Mobile devices typically have only a limited amount of battery capacity available to perform computationally intensive functions such as image detection, sampling, compression, decompression, and display. A particularly limited battery capacity is available in smaller, lighter devices such as headsets or other accessories and smart space devices such as RFID tags.

Often, multimedia information is first sampled and stored with a high resolution according to Shannon sampling theorem which states that if you sample densely enough (greater than the Nyquist rate), you can perfectly reconstruct the original data. This is known as lossless data compression. The data sampled through the Shannon sampling theorem may then be transformed into some expansion coefficients to be used in a proper decoding environment to generate the original image. A method that requires less data is to sample only the relevant information that is required to re-generate the original or nearly equal to the original multimedia. This method is referred to as compressed sampling (or sensing) which is a form of lossy data compression. Each compressed sensing result is an inner product of measurement and different test functions. For optimum sensing, the test functions may resemble random noise without any relation to image content. Compressing is possible only in those cases when information is compressible, i.e., in cases where the original content is possible to be reconstructed from smaller amounts of information than would be required through the Shannon sampling theorem requirement of the Nyquist sampling rate.

Natural images are often compressible in the discrete wavelet basis. The Joint Photography Experts Group (JPEG) and JPEG-2000 compression standards are based on wavelets. The display of a mobile device may include a decompression module or decoder that may be used to display content produced by a mobile device itself, downloaded content through local and cellular networks, content from other mobile devices using near-field communication (NFC), or from the Internet using wireless local connectivity or cellular networks. Simple Radio Frequency (RF) memory tags with content memory, simple cameras, or other known devices may also provide content for display on a mobile device.

Content displayed on a mobile device or on any type of device, such as a personal computer (PC), must be decompressed in order to be displayed. Such decompression can require significant computational resources.

### BRIEF SUMMARY

A method, apparatus, and computer program product are therefore provided for receiving compressed sensed data at a device and providing for decompression of the compressed sensed data at a delegated resource or at multiple delegated resources. In general, example embodiments of the present invention provide an improvement by, among other things, providing a method of using resources with superior processing capacity and/or power capacity for computationally intensive decompression of compressed sensed data.

In one embodiment of the present invention, a method is provided that includes receiving compressed sensed data, determining a target recipient device for decompressed data, determining the appropriate decompressed data format for the decompressed data, and determining a delegated resource to select for decompression of the compressed sensed data. Decompression of the compressed sensed data results in the decompressed data. The method may further include providing for transmission of a target recipient device for the decompressed data, providing for transmission of the decompressed data format of the decompressed data, and providing for transmission of the compressed sensed data to the delegated resource. The decompressed data format for the decompressed data may be determined by the capabilities of the target recipient device. Determining the delegated resource may include analyzing the available resources for processing capability or for power capacity. The target recipient device for the decompressed data may be the delegated resource. Providing for transmission of the compressed sensed data may include streaming the compressed sensed data as it is received. Providing for transmission of the compressed sensed data may be performed in response to receiving a request for the transmission of the compressed sensed data.

According to another embodiment of the invention, an apparatus is provided that includes at least one processor and at least one memory including computer program code. The at least one memory and the computer program code are configured to, with the at least one processor, cause the apparatus to receive compressed sensed data, determine a target recipient device for decompressed data, determine the appropriate decompressed data format for the decompressed data, and determine a delegated resource to select for decompression of the compressed sensed data. Decompression of the compressed sensed data may result in the decompressed data in the decompressed data format. The apparatus may further be caused to provide for transmission of a target recipient device of the decompressed data, provide for transmission of the decompressed data format of the decompressed data, and provide for transmission of the compressed sensed data to the delegated resource. The decompressed data format for the decompressed data may be determined by the capabilities of the target recipient device. To determine the delegated resource, the apparatus may be caused to analyze the available resources for processing capability and/or power capacity. The target recipient device for the decompressed data may be the delegated resource. Transmitting the compressed sensed data may include streaming the compressed sensed data as it is received. Transmitting the compressed sensed data may be performed in response to receiving a request for transmission of the compressed sensed data.

According to yet another embodiment of the invention, a computer program product is provided that includes at least one computer-readable storage medium having computer-executable program code instructions stored therein. The computer-executable program code instructions of this embodiment include program code instructions for receiving compressed sensed data, determining a target recipient device for decompressed data, and determining a delegated resource to select for decompression of the compressed sensed data. Decompression of the compressed sensed data may result in decompressed data in the decompressed data format. The computer-executable program code instructions may further include program code instructions for providing for transmission of a target recipient device of the decompressed data, providing for transmission of the decompressed data format of the decompressed data, and providing for transmission of the compressed sensed data to the delegated resource. The decompressed data format for the decompressed data may be determined by the capabilities of the target recipient device. The computer-executable program code instructions may further include program code instructions for analyzing the available resources for processing capability or power capacity in order to determine a delegated resource. The target recipient device for the decompressed data may be the delegated resource. The computer-executable program code instructions for providing for transmission of the compressed sensed data may include program code instructions for streaming the compressed sensed data as it is received.

### BRIEF DESCRIPTION OF THE SEVERAL VIEWS OF THE DRAWING(S)

Having thus described embodiments of the invention in general terms, reference now will be made to the accompanying drawings, which are not necessarily drawn to scale, and wherein:

FIG. 1 is a block diagram of a mobile device, according to one embodiment of the present invention;

FIG. 2 is a schematic representation of a system for supporting embodiments of the present invention;

FIG. 3 is a schematic representation of a method according to an example embodiment of the present invention;

FIG. 4 is an illustration according to an example embodiment of the present invention;

FIG. 5 is a flow chart of the operations performed in accordance with one embodiment of the present invention; and

FIG. 6 is a flow chart of the operations performed in accordance with another embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

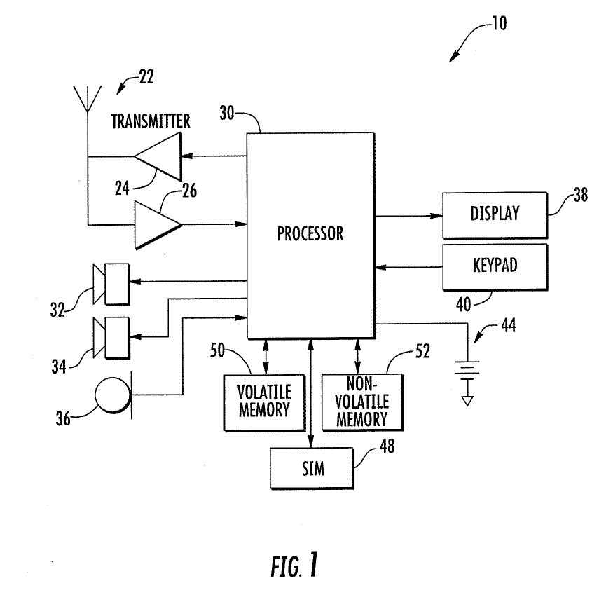

Although a mobile device may be configured in various manners, one example of a mobile device that could benefit from embodiments of the invention is depicted in the block diagram of FIG. 1. While one embodiment of a mobile device will be illustrated and hereinafter described for purposes of example, other types of mobile devices, such as portable digital assistants (PDAs), pagers, mobile televisions, gaming devices, all types of computers (e.g., laptops or mobile computers), cameras, audio/video players, radios, or any combination of the aforementioned, and other types of mobile devices, may employ embodiments of the present invention. As described, the mobile device may include various means for performing one or more functions in accordance with embodiments of the present invention, including those more particularly shown and described herein. It should be understood, however, that a mobile device may include alternative means for performing one or more like functions, without departing from the spirit and scope of the present invention.

The mobile device 10 of the illustrated embodiment includes an antenna 22 (or multiple antennas) in operable communication with a transmitter 24 and a receiver 26. The mobile device may further include an apparatus, such as a processor 30, that provides signals to and receives signals from the transmitter and receiver, respectively. The signals may include signaling information in accordance with the air interface standard of the applicable cellular system, and/or may also include data corresponding to user speech, received data and/or user generated data. In this regard, the mobile device may be capable of operating with one or more air interface standards, communication protocols, modulation types, and access types. By way of illustration, the mobile device may be capable of operating in accordance with any of a number of first, second, third and/or fourth-generation communication protocols or the like. For example, the mobile device may be capable of operating in accordance with second-generation (2G) wireless communication protocols IS-136, global system for mobile communications (GSM) and IS-95, or with third-generation (3G) wireless communication protocols, such as universal mobile telecommunications system (UMTS), code division multiple access 2000 (CDMA2000), wideband CDMA (WCDMA) and time division-synchronous code division multiple access (TD-SCDMA), with 3.9G wireless communication protocol such as E-UTRAN (evolved-UMTS terrestrial radio access network), with fourth-generation (4G) wireless communication protocols or the like. The mobile device may also be capable of operating in accordance with local and short-range communication protocols such as wireless local area networks (WLAN), Bluetooth (BT), Bluetooth Low Energy (BT LE), ultra-wideband (UWB), radio frequency (RF), and other near field communications (NFC).

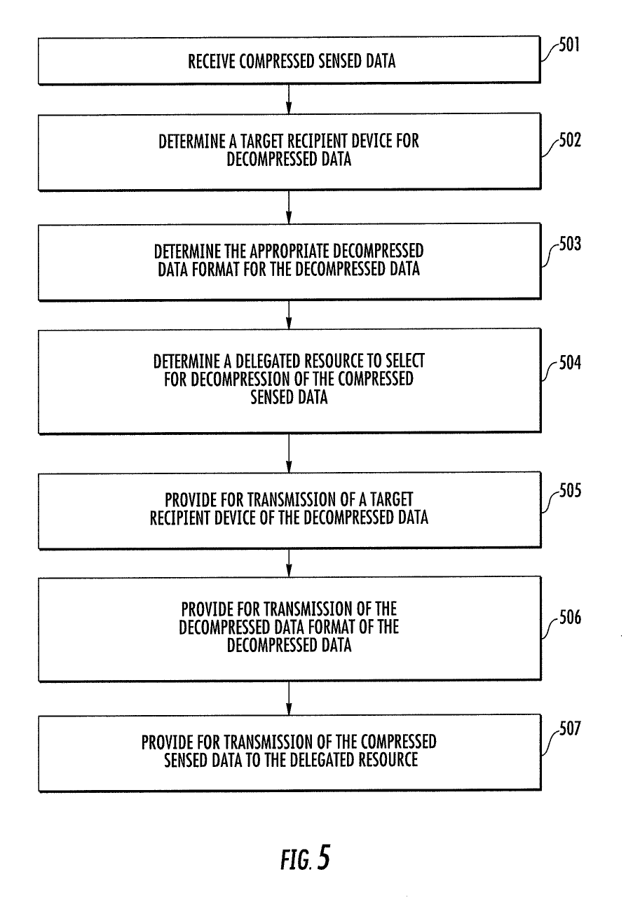

It is understood that the apparatus, such as the processor 30, may include circuitry implementing, among others, audio and logic functions of the mobile device 10. The processor may be embodied in a number of different ways. For example, the processor may be embodied as various processing means such as processing circuitry, a coprocessor, a controller or various other processing devices including integrated circuits such as, for example, an ASIC (application specific integrated circuit), an FPGA (field programmable gate array), a hardware accelerator, and/or the like. In an example embodiment, the processor is configured to execute instructions stored in a memory device or otherwise accessible to the processor. As such, whether configured by hardware or software methods, or by a combination thereof, the processor 30 may represent an entity capable of performing operations according to embodiments of the present invention, including those depicted in FIG. 5, while specifically configured accordingly. The processor may also include the functionality to convolutionally encode and interleave message and data prior to modulation and transmission.

The mobile device 10 may also comprise a user interface including an output device such as an earphone or speaker 34, a ringer 32, a microphone 36, a display 38 (including normal and/or bistable displays), and a user input interface, which may be coupled to the processor 30. The user input interface, which allows the mobile device to receive data, may include any of a number of devices allowing the mobile device to receive data, such as a keypad 40, a touch display (not shown) or other input device. In embodiments including the keypad, the keypad may include numeric (0-9) and related keys (#, *), and other hard and soft keys used for operating the mobile device. Alternatively, the keypad may include a conventional QWERTY keypad arrangement. The keypad may also include various soft keys with associated functions. In addition, or alternatively, the mobile device may include an interface device such as a joystick or other user input interface. The mobile device may further include a battery 44, such as a vibrating battery pack, for powering various circuits that are used to operate the mobile device, as well as optionally providing mechanical vibration as a detectable output.

The mobile device 10 may further include a user identity module (UIM) 48, which may generically be referred to as a smart card. The UIM may be a memory device having a processor built in. The UIM may include, for example, a subscriber identity module (SIM), a universal integrated circuit card (UICC), a universal subscriber identity module (USIM), a removable user identity module (R-UIM), or any other smart card. The UIM may store information elements related to a mobile subscriber. In addition to the UIM, the mobile device may be equipped with memory. For example, the mobile device may include volatile memory 50, such as volatile Random Access Memory (RAM) including a cache area for the temporary storage of data. The mobile device may also include other non-volatile memory 52, which may be embedded and/or may be removable. The non-volatile memory may additionally or alternatively comprise an electrically erasable programmable read only memory (EEPROM), flash memory or the like. The memories may store any of a number of pieces of information, and data, used by the mobile device to implement the functions of the mobile device. For example, the memories may include an identifier, such as an international mobile equipment identification (IMEI) code, capable of uniquely identifying the mobile device.

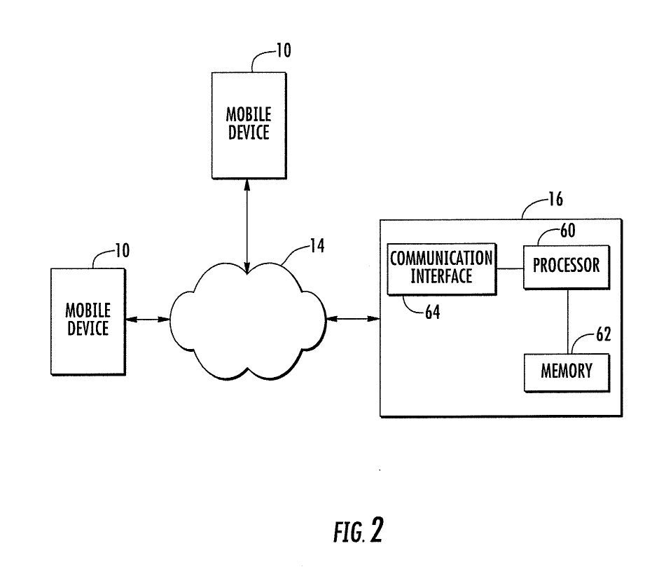

The mobile device 10 may be configured to communicate via a network 14 with a network entity 16, such as a server as shown in FIG. 2, for example. The network may be any type of wired and/or wireless network that is configured to support communications between various mobile devices and various network entities. For example, the network may include a collection of various different nodes, devices or functions such as the server, and may be in communication with each other via corresponding wired and/or wireless interfaces. Server functionality may reside, for example, in an overlay network or a gateway such as Nokia's Ovi service. Although not necessary, in some embodiments the network may be capable of supporting communications in accordance with any one of a number of first-generation (1G), second-generation (2G), 2.5G, third-generation (3G), 3.5G, 3.9G, fourth-generation (4G) level communication protocols, long-term evolution (LTE) and/or the like.

As shown in FIG. 2, a block diagram of a network entity 16 capable of operating as a server or the like is illustrated in accordance with one embodiment of the present invention. The network entity may include various means for performing one or more functions in accordance with embodiments of the present invention, including those more particularly shown and described herein. It should be understood, however, that the network entity may include alternative means for performing one or more like functions, without departing from the spirit and scope of the present invention.

In the illustrated embodiment, the network entity 16 includes means, such as a processor 60, for performing or controlling its various functions. The processor may be embodied in a number of different ways. For example, the processor may be embodied as various processing means such as processing circuitry, a coprocessor, a controller or various other processing devices including integrated circuits such as, for example, an ASIC, an FPGA, a hardware accelerator, and/or the like. In an example embodiment, the processor is configured to execute instructions stored in memory or otherwise accessible to the processor. As such, whether configured by hardware or software methods, or by a combination thereof, the processor 60 may represent an entity capable of performing operations according to embodiments of the present invention while specifically configured accordingly.

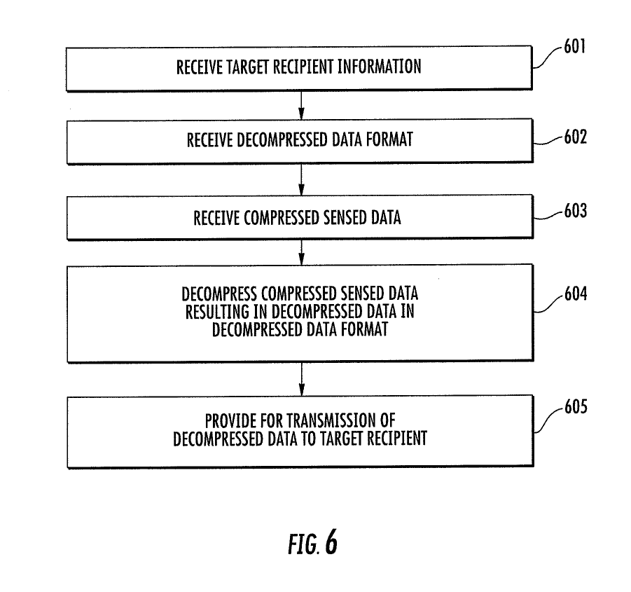

In one embodiment, the processor 60 is in communication with or includes memory 62, such as volatile and/or non-volatile memory that stores content, data or the like. For example, the memory may store content transmitted from, and/or received by, the network entity. Also for example, the memory may store software applications, instructions or the like for the processor to perform operations associated with operation of the network entity 16 in accordance with embodiments of the present invention. In particular, the memory may store software applications, instructions or the like for the processor to perform the operations described above and below with regard to FIGS. 5 and 6. In addition to the memory 62, the processor 60 may also be connected to at least one interface or other means for transmitting and/or receiving data, content or the like. In this regard, the interface(s) can include at least one communication interface 64 or other means for transmitting and/or receiving data, content or the like, such as between the network entity 16 and the mobile device 10 and/or between the network entity and the remainder of network 14.

Mobile devices, such as 10 of FIG. 1 may be configured to display or present various forms of multimedia (e.g., video, audio, pictures, etc.) to a user. The multimedia may be in the form of a file that is received by the device or streaming data that is received by the device. Mobile devices may also be configured to receive or record data, such as multimedia or other forms of data as will be discussed below, and transmit the data elsewhere for presentation. Accessories for mobile devices, such as headset cameras or the like may be configured to receive data and transmit the data via Bluetooth or other communications protocols. The data as acquired by the acquisition device (e.g., mobile device, accessory device, etc.) may require different conversions in order to be displayed or presented on different types of devices. For example a video captured on a mobile device camera may be displayed on the screen of the mobile device in a first resolution, scale, and quality, while it may also be presented on a large television where a larger size, higher resolution, and higher quality presentation is desired.

By way of example, multimedia may be in a variety of formats in a wide variety of qualities. Multimedia providers and device manufacturers may wish to provide a mobile device user with pictures and videos that are up to High Definition Television (HDTV) quality to maximize user satisfaction. Such multimedia quality may be achieved using content sampling at the Nyquist sampling frequency which results in large amounts of data required for storage and decoding of the multimedia signal. An alternative to sampling at the Nyquist sampling frequency is to use compressed sampling in which multimedia is reconstructed from a much smaller amount of information than what the Nyquist theorem requires. With compressed sampling or compressed sensing, an original signal may be encoded at the source and decoded at the display to minimize the transmitted or stored data volume. For example a mobile device may capture a video in compressed sensed encoding and the data must be decompressed for presentation. The encoding and decoding steps of the process may become computationally intensive.

Compressed sensing is a method of acquiring or sampling data while simultaneously compressing it. Conventional data acquisition may acquire data at a high rate, and compressing the data after it is acquired. Acquiring a great deal of data at a high rate, and then discarding a significant portion of the data during compression may be inefficient since it requires more computational power and a higher rate of data acquisition. Compressed sampling compresses the data as the data is sampled, reducing the amount of acquired data and reducing the amount of discarded data from separate compression thus reducing the required computational power. Compressed sensing may acquire data at a lower frequency or greater sparsity to reduce the acquired data. Further compression may be performed in compressed sensing through coders such as JPEG2000; however, since less data is processed, less computational power is required.

Compressed sensing exploits the redundancies in data that would be acquired according to the Shannon theorem. Compressed sensing acquires a sparse signal in an efficient way of sub-sampling such that the data acquired can be reconstructed to represent the original, uncompressed signal. The compressed sensed data can be acquired at a random or pseudo-random interval using uncertainty principles. The data is subsequently reconstructed through a decompression step that involves a set of compressed measurement tools or a recovery algorithm.

Mobile devices, such as 10 of FIG. 1, often have limited battery capacity as small-size and low-weight tend to be desirable features of mobile devices. Computationally intensive processes, e.g., processes that require significant resources from components such as a processor 30, tend to require additional power from the power source or battery 44. The additional power draw on the battery decreases battery life more significantly than typical, non-computationally intensive processes performed by a mobile device 10. Thus, it may be desirable to delegate computationally intensive processes to other resources that are in communication with the mobile device. The other resources used by the mobile device may be servers, personal computers, or other devices capable of performing the computationally intensive processes. The other resources may further be configured with superior power resources such as a wired power connection to a utility grid, a larger battery with more power, such as a laptop with a built-in battery, or other power resources that may be more capable than the power supply typically afforded by a mobile device.

When a picture is taken, a video is captured, an audio track is recorded, or sensor data is recorded, the data is often acquired at or above the Nyquist sampling frequency according to the Shannon sampling theorem, resulting in large amounts of data acquired and stored, at least temporarily, on a storage medium. The large amount of captured data may then be compressed to a smaller format that is capable of accurately reproducing the multimedia with significantly less data. This compression requires significant processing capacity. The aforementioned method requires both significant storage capacity and significant processing capacity. Compressed sensing combines the acquisition and compression such that they are performed at the same time reducing both the storage requirement and processing required for separate compression encoding of the data. For example, traditionally a picture may be acquired at a 5-megapixel resolution and requiring 5 megabytes of storage before being compressed to 300 kilobytes by a compression encoding step. With compressed sensing, only 1.5 megabytes of information may need to be acquired in total.

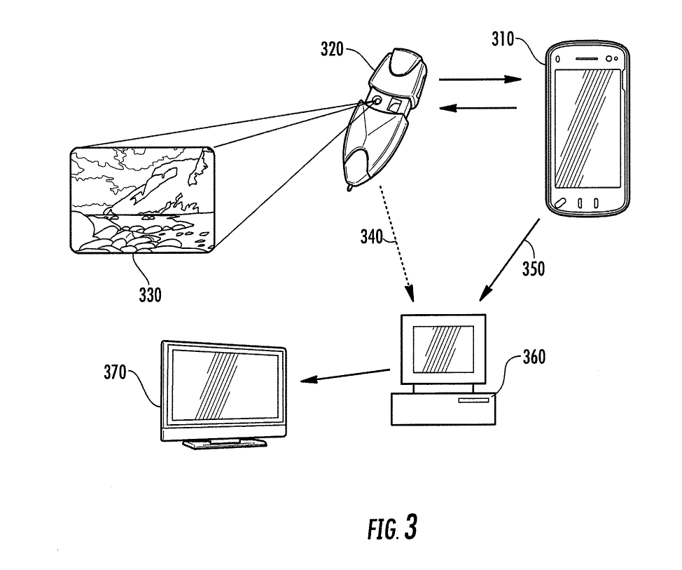

An example embodiment of the present invention is illustrated in FIG. 3 in which a user device 310 may be associated with an accessory device such as the headset camera 320 of FIG. 3. The headset camera 320 may be a small, light weight device with relatively low storage capacity and relatively low battery capacity. The headset camera 320 may acquire still pictures (e.g., 330), video, and/or audio and use compressed sensing to acquire the data. Acquiring the data using compressed sensing may consume substantially less power from the accessory device and require less storage space than sensing using the Shannon sampling theorem as noted above. The data acquired from the compressed sensing may then be transmitted to a delegated resource 360. The transmitting can be performed by the accessory device 320 through a local communication protocol such as Bluetooth or WLAN among others 340, or the accessory device may transmit the data to the associated user device 310 whereupon the associated user device may transmit the compressed sensed data 350 to the delegated resource 360 via any communication means available. The delegated resource 360 may be a personal computer, a network server, a display such as a television or computer monitor, or any other resource that is capable of processing the data transmitted from the accessory device 320. A delegated resource may reside within a service provider's network, for example, within Nokia's Ovi service. The delegated resource 360 may then decompress the data that was received in the format generated by the compressed sensing. The delegated resource 360 may decompress the data to a format that is specified by the mobile device or by a target device to which the multimedia is to be presented. Such formats may include HDTV (1080p, 720p, or 1080i) or 320-pixels×240-pixels, among countless others for video or pictures, and formats such as 16-bit/60 Hz or 32-bit/120 Hz, among many others, for audio. The format may be determined based on the capabilities of the target device or on the bandwidth available for transmission. The decompression may be computationally intensive and may consume relatively large amounts of processing power, thereby consuming relatively large amounts of power from the power source. The delegated resource may have substantially greater power resources and potentially, substantially greater computational or processing abilities than a mobile device may have. The delegated resource 360 may then transmit the decompressed signal to the target device 370; however, the delegated resource and the target device may be the same device (e.g., the decompressed data from the delegated resource 360 may be supplied back to the user device 310 for display or presentation).

Another example embodiment of the present invention may use the user device itself as the delegated resource. As the headset camera of the embodiment illustrated in FIG. 3 has relatively little computational power and relatively little storage space, the user device 310 may be the only available resource in communication with the headset camera 320. The user device 310 may be isolated and not in communication with any other devices such that the user device 310 becomes the best available resource for delegation. While the user device may not have a high level of computational power and may not have a great deal of battery capacity, it may be the best available resource for performing the decompression of the data.

While the above examples relate to multimedia processing, similar processes may be used in the acquisition of other data, such as sensor data that is acquired by sensors that have minimal computational or storage capacity. Such sensors may be part of an RFID tag that senses environmental conditions including temperature, humidity, barometric pressure, etc or tags that include strain gages among other types of sensors. The tag with sensor may perform compressed sensing encoding and stream the results continuously for decompression provided the tag is active and activated. Optionally, the tag may create a log file to collect larger amounts of sensed information in a compressed format for a larger file and send the file periodically for decompression or when the data has been requested from the tag. Such tags may be used in environments such as a bridge where monitoring of strain gages on the bridge assists in determining when and where structural issues might arise as in the example embodiment below.

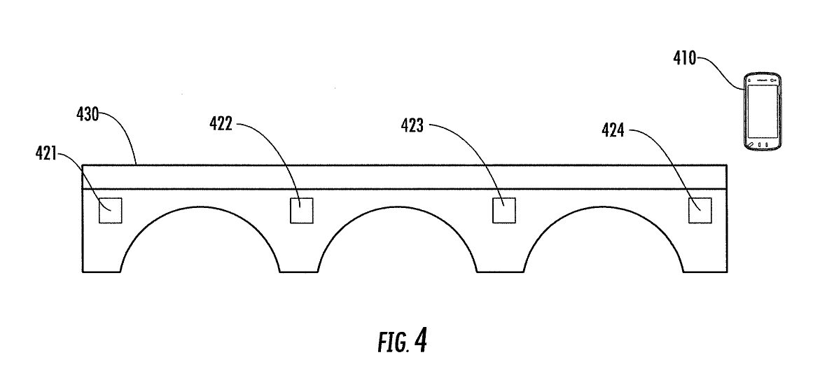

An example embodiment of the present invention is illustrated in FIG. 4 where a bridge 430 may be outfitted with a series of RF tags (421-424) with embedded strain gage sensors. Hard wiring such tags may be impractical due to the environment and the length of wire that may be required. Further, a daisy chain of sensors may be more prone to systemic failures than individual, self contained sensors. The tags may be configured to continuously monitor stress and strain at their respective locations and collect data in a compressed sensing format. A mobile device 410 may be configured to communicate with each tag when it is in proximity to each tag 421-424. The mobile device 410, in particular, the processor 30, may collect the compressed sensed data from the tags and either decompress it at the mobile device, or transmit it to a delegated resource for decompression.

RF memory tags may be used for embodiments of the present invention where a RF memory tag is capable of relatively fast data transfer and higher storage capacity than typical RFID tags. A passive RF memory tag, or device that acts as a passive RF memory tag that includes an embedded tag, may be activated by a signal from a source, such as a mobile device where the signal from the device excites the tag and generates enough power for the tag to transmit to the device. The mobile device may be a mobile reader/writer configured to read and write to RF memory tags. Active RF memory tags that include their own power source may also be used in embodiments of the present invention. Such a system may be used in the embodiment of the present invention illustrated in FIG. 4. The RF tags of FIG. 4 may each be active, they may each be passive, or they may be a combination of the two. For example, RF tags 421 and 423 may be passive and tag 422 may be active. The active tag may activate the passive tag and retrieve compressed sensed data from the passive tags for transmission to a mobile device or another location, such as a delegated resource. Further, the active tag 422 itself may be the delegated resource used by the passive tags 421 and 423. The delegated resource may be any tag or device with sufficient power and processing capability to decompress the compressed sensed data.

Example embodiments of the present invention may include accessory devices or tags that have sufficient processing capabilities to ascertain the best delegated resource to perform the decompression of the sensed data. The accessory device or the mobile device, dependent upon which device is transmitting the compressed data, may survey the available resources to determine which resource may be best suited to perform the decompression of the data. Factors that may influence which resource is selected as the delegated resource may include processing capability, power capacity, proximity to the mobile device or accessory device, data transfer speed to/from the resource, and communication channels available to the resource (e.g., Bluetooth, Wi-Fi, etc.).

FIG. 5 is a flowchart of a method according to an example embodiment of the present invention. An accessory device or a mobile device may receive compressed sensed data at operation 501. The accessory device or mobile device may include a data capture element such as a camera, microphone, or other data sensing instrument to receive the compressed sensed data, which may be in the form of a video or other data. The device may determine a target recipient device for the decompressed data which may be a television, a mobile device, a personal computer, etc. at operation 502. The target recipient may be known before receiving the compressed sensed data, particularly if the data is to be streamed to the target recipient, or the target recipient may not be determined until after the compressed sensed data is received and stored for a period of time. The appropriate decompressed data format for the target recipient may be determined at operation 503. The format may be determined by the accessory device or mobile device, or the target recipient may be requested to provide the desired decompressed data format. A delegated resource is then determined at operation 504. The delegated resource may be determined based on available power and/or processing capacity and it may be selected from a plurality of available resources. The target recipient information may then be transmitted to the delegated resource at operation 505. The desired format of the decompressed data may be transmitted to the delegated resource at operation 506. At operation 507, the compressed sensed data may be transmitted to the delegated resource for decompression.

FIG. 6 is a flowchart of a method according to an example embodiment of the present invention. The target recipient information may be received at operation 601. The decompressed data format may be received at operation 602. At operation 603, the compressed sensed data is received, which may be in the form of streaming data or it may be a data file. The compressed sensed data is decompressed at operation 604 where the compressed sensed data is transformed to the decompressed data format received at operation 602. The decompressed data is transmitted to the target recipient at operation 605.

As described above, FIGS. 5 and 6 are flowcharts of an apparatus, method and program product according to some exemplary embodiments of the invention. It will be understood that each block of the flowcharts, and combinations of blocks in the flowcharts, can be implemented by various means, such as hardware, firmware, and/or computer program product including one or more computer program instructions. For example, one or more of the procedures described above may be embodied by computer program instructions. In this regard, the computer program instructions which embody the procedures described above may be stored by a memory device, such as 50, 52, or 62, of a mobile device 10, network entity such as a server 16 or other apparatus employing embodiments of the present invention and executed by a processor 30, 60 in the mobile device, server or other apparatus. In this regard, the operations described above in conjunction with the diagrams of FIGS. 5 and 6 may have been described as being performed by the communications device and a network entity such as a server, but any or all of the operations may actually be performed by the respective processors of these entities, for example in response to computer program instructions executed by the respective processors. As will be appreciated, any such computer program instructions may be loaded onto a computer or other programmable apparatus (i.e., hardware) to produce a machine, such that the instructions which execute on the computer (e.g., via a processor) or other programmable apparatus implement the functions specified in the flowcharts block(s). These computer program instructions may also be stored in a computer-readable memory, for example, memory 62 of server 16, that can direct a computer (e.g., the processor or another computing device) or other apparatus to function in a particular manner, such that the instructions stored in the computer-readable memory produce an article of manufacture including instructions which implement the functions specified in the flowcharts block(s). The computer program instructions may also be loaded onto a computer or other apparatus to cause a series of operations to be performed on the computer or other apparatus to produce a computer-implemented process such that the instructions which execute on the computer or other programmable apparatus provide operations for implementing the functions specified in the flowcharts block(s).

Accordingly, blocks of the flowcharts support combinations of means for performing the specified functions, combinations of operations for performing the specified functions and program instructions for performing the specified functions. It will also be understood that one or more blocks of the flowcharts, and combinations of blocks in the flowcharts, can be implemented by special purpose hardware-based computer systems which perform the specified functions, operations, or combinations of special purpose hardware and computer instructions.

In an exemplary embodiment, an apparatus for performing the methods of FIGS. 5 and 6 may include a processor (e.g., the processor(s) 30 and/or 60) configured to perform some or each of the operations (501-507 and/or 601-605) described above. The processor(s) may, for example, be configured to perform the operations (501-507 and/or 601-605) by performing hardware implemented logical functions, executing stored instructions, or executing algorithms for performing each of the operations. Alternatively, the apparatus, for example server 16, may comprise means for performing each of the operations described above. In this regard, according to an example embodiment, examples of means for performing operations 501-507 and/or 601-605 may comprise, for example, the processor(s) 30 and/or 60 as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
determining a target recipient device for decompressed data;
determining a decompressed data format for the decompressed data;
determining a delegated resource to select for decompression of compressed sensed data, wherein decompression of the compressed sensed data results in the decompressed data in the decompressed data format; and
providing for transmission of the compressed sensed data to the delegated resource.

2. A method according to claim 1, wherein the determining the decompressed data format for the decompressed data comprises determining the decompressed data format at least partially based on the capabilities of the target recipient device.

3. A method according to claim 1, wherein determining a delegated resource includes analyzing available resources for processing capability.

4. A method according to claim 1, wherein determining a delegated resource includes analyzing available resources for power capacity.

5. A method according to claim 1, wherein the target recipient device for the decompressed data is the delegated resource.

6. A method according to claim 1, wherein providing for transmission of the compressed sensed data comprises providing for streaming of the compressed sensed data as the compressed sensed data is received.

7. A method according to claim 1, wherein providing for transmission of the compressed sensed data is performed in response to receiving a request for transmission of the compressed sensed data.

8. An apparatus comprising at least one processor and at least one memory including computer program code, the at least one memory and the computer program code configured to, with the at least one processor, cause the apparatus to:
determine a target recipient device for decompressed data;
determine a decompressed data format for the decompressed data;
determine a delegated resource to select for decompression of compressed sensed data, wherein decompression of the compressed sensed data results in the decompressed data in the decompressed data format; and
provide for transmission of the compressed sensed data to the delegated resource.

9. An apparatus according to claim 8, wherein determining the decompressed data format for the decompressed data comprises determining the decompressed data format at least partially based on the capabilities of the target recipient device.

10. An apparatus according to claim 8, wherein determining a delegated resource includes analyzing available resources for processing capability.

11. An apparatus according to claim 8, wherein determining a delegated resource includes analyzing available resources for power capacity.

12. An apparatus according to claim 8, wherein the target recipient device for the decompressed data is the delegated resource.

13. An apparatus according to claim 8, wherein providing for transmission of the compressed sensed data comprises providing for streaming of the compressed sensed data as the compressed sensed data is received.

14. An apparatus according to claim 8, wherein providing for transmission of the compressed sensed data is performed in response to receiving a request for transmission of the compressed sensed data.

15. A computer program product comprising at least one computer-readable storage medium having computer-executable program code instructions stored therein, the computer-executable program code instructions comprising:
program code instructions for determining a target recipient device for decompressed data;
program code instructions for determining a decompressed data format for the decompressed data;
program code instructions for determining a delegated resource to select for decompression of the compressed sensed data wherein decompression of the compressed sensed data results in the decompressed data in the decompressed data format; and
program code instructions for providing for transmission of the compressed sensed data to the delegated resource.

16. A computer program product according to claim 15, wherein the program code instructions for determining the decompressed data format for the decompressed data comprises program code instructions for determining the decompressed data format at least partially based on the capabilities of the target recipient device.

17. A computer program product according to claim 15, wherein the program code instructions for determining a delegated resource includes program code instructions for analyzing available resources for processing capability.

18. A computer program product according to claim 15, wherein the program code instructions for determining a delegated resource includes program code instructions for analyzing available resources for power capacity.

19. A computer program product according to claim 15, wherein the target recipient device for the decompressed data is the delegated resource.

20. A computer program product according to claim 15, wherein the program code instructions for providing for transmission of the compressed sensed data comprises program code instructions for providing for streaming of the compressed sensed data as the compressed sensed data is received.
